(19) United States
(12) Patent Application Publication
(10) Pub. No.: US 2021/0308893 A1
(43) Pub. Date: Oct. 7, 2021

(54) PANTOGRAPH MACHINE EQUIPPED WITH BLADES AND HOT-CUTTING PRE-SHAPED PUNCHES AND CUTTERS FOR PROCESSING PANELS, IN PARTICULAR ICF PANELS WITH EXPANDED OR FOAMED MATERIALS IN GENERAL

(71) Applicant: Michele CABONI, Oristano (IT)

(72) Inventor: MICHELE CABONI, ORISTANO (IT)

(21) Appl. No.: 14/363,835

(22) PCT Filed: Dec. 7, 2012
(86) PCT No.: PCT/IT2012/000371

§ 371 Date: Jul. 30, 2014

(30) Foreign Application Priority Data
Dec. 9, 2011 (IT) TO2011A001129

(51) Int. Cl. B26D 3/00; B23Q 1/46; B44B 3/00; B26F 3/12; B26D 1/04; E04C 2/20

(52) U.S. Cl. CPC B26D 3/006; B23Q 1/46; B44B 3/002; E04B 2/86; B26D 1/04; E04C 2/205; B26F 3/12

(57) ABSTRACT

Pantograph machine (1) equipped with cutting blades hot punches pre-shaped, and drills, for machining panels, in particular slabs and ICF panels, with foamed materials or extruded, comprising at least a first station (1) consisting of at-least a castle (1′), supported by a base (2) which houses a supporting surface (3), the castle (1′) comprising: at least one frame (5) carrying punches-cutting blades (6) connected operatively to a frame-carrier carriage (9) sliding on guides, and moved by means of a transmission; at least two slides (23) for milling, performed by a tool (24) mounted on an electro-spindle (25), place on a carriage (14); at least-one frame (15) carrying wires (16) operatively connected to a frame-carrier carriage (19) sliding on guides (10) and moved by means a transmission.

### BACKGROUND OF THE INVENTION

### Field of the Invention

The present invention refers to a pantograph machine equipped with blades and hot-cutting pre-shaped punches and cutters, for machining panels, in particular ICF panels, with foamed or extruded materials in general (hereinafter for brevity called “machine”).

### Description of the Prior Art

Conventional pantographs are known in the art for continuous cutting of slabs (to flat surfaces, but not perfectly coplanar in the thickness) made of expanded polystyrene, such as the cutting line numerical control Model ECO IV 4000 M2000 of DDL Ltd Such slabs, however, does not have a specific application for industrialized building, since, as currently designed hot wires of such pantographs, the slabs resulting from the cut are not suitable application in construction not suitable application in building energy-saving, environmentally friendly, as for example to build long-lasting elements perfectly modular and/or calibrated with corrugated surfaces at the same time, micro-ribbed with longitudinal grooves and undercuts lattice, with dovetails negative and positive in their facades unlimited conformation, even the most disparate.

Historically and currently, however, in the building industry, worldwide, all panels ICF origin of American and California’ are always printed on smooth facades, limited to pieces of medium size and no more than 30/40 centimeter high, by specific aluminum molds suitably molded and shaped for the purpose, and for this, if not last, reason serve multiple molds of aluminum to produce obviously only one type of panel ICF outlined in its shapes and sizes such as length and thickness height, certainly not in said mold is made of aluminum can produce simultaneously a plurality of thicknesses and/or forms of panels ICF, above all the same,’ co-molded with plastic inserts PP. In fact, we face high investment only for their specific design and purchase them, thereby implying equally high costs due to the large steam needed for the sintering of virgin EPS beads/PSE, and with obvious disadvantage of the remarkable timing of molding, for the production of such, panels ICF, through appropriate printers and modified for the purpose, which are also very costly in purchase and management, not ‘easily available in the industries and in the world market.

The present invention relates to the rapid manufacturing of elements of any geometry with even the most complex shapes and without bond materials, and in particular the realization of EPS foam panels and/or extruded of any shape, size and in length, height and thickness, or having multiple and submultiples measures, known internationally as ending scientific INSULATED CONCRETE FORM (ICF), contrary to the common conception of molding has become obsolete and static to get the same products made by the machine in question with the classic molding obsolete arid static, it would take a large number of molds, dedicated to the type of panel ICF or other items, which may not allow you to print certain ICF panels, above all, it becomes almost impossible if you do not print special pieces as decorations, string courses, capitals, borders, window and door insulation, thermal containers in general, satisfying the requirements mentioned above, and an equal number of special and special printing presses, with obvious and consequent high investment.

Moreover, the machines used for the molding of panels only present in the industries and on the world market are not always adaptable to technical molds integral carriages with sliding pistons, defined complexes, in which during the pre-molding are integrated plastic inserts from co-print during the production cycle.

This, obsolete moldi-ng system described is not only very costly both in the times at both the molding costs of said panels ICF or other thermally insulating elements.

From all this, are deduced the dynamic and exclusive elasticity of the machine in question, either as a capacity to adapt to any type of product to be produced and the type of production, both as variability of composition depending on the product to be cut and/or milling, they are hollow blocks in the most diverse shapes, ICF panels of any size in thickness, height and length, cornices in the most, disparate types and conformation, they also stringcourses in the most diverse types and shapes, decorative capitals and jambs decorative doors and windows designed to encapsulate’ frames generally high value insulation, arches and arches, and so serves no restrictions to create these elements in monolithic (inner face with hollow “T” and/or “cross” for the ‘of housing any type of connector need for the conjunction of multiple types of components, thus obtaining an obvious advantage in’ assembly of a formwork ICF, and the housing bound the longitudinal rods and the stirrups horizontal variable pitch, (according to the known reinforcement steel) of respectful all international standards in terms of energy savings, soundproof and structural.

However, as seen, the machines of an old design notes for cutting polystyrene and similar material are only a heated wire for “Joule effect” by means of electrical energy, and fail to realize, of course, a cut coplanar calibrated and perfect, especially when working elements and/or panels over the linear meter. Therefore, the complete machining, defined in a production cycle, of the very few items that you would be able to realize would lead to high costs and with obvious times that are acceptable.

### SUMMARY OF THE INVENTION

The purpose of the present invention is to construct a modular machine according to requirements, able to work quickly, and polyhedral, that is constructively very simple and inexpensive it from the basic model, with a very high operating speed because of the unique and innovative technology applied based on multiple wires and shaped dies even in the most diverse conformations heated for “Joule effect” through electricity via a temperature controller and multiple cutters properly shaped for the purpose, all controlled by CNC and software specific.

The inventive machine is extremely versatile, it does combine all the best features of the machine's main feature is that it can integrate a number of different cutting technologies: oscillating blade, rotary blade and cutting line (with an additional kit), a number of advantages for easily produce any type of product in any material.

The inventive Machine and advantageously producible in a plurality of versions that differ from each other only for the trim size and type of materials to be machined.

Loading and unloading of the block preferably expanded polystyrene EPS to be cut is facilitated by the roller system and by the conveyor belts. on the working plane, that automatically rotates to make a cut in accordance with the same. shape rotated 90° in the working plane.

The automation of the inventive machine is controlled by the software of the personal computer, the same included into the control panel.

To recognize the outline of the specific drawing of the article to be cut and/or milling, it is possible to use: the table digitizer, scanner, or even a drawing made with a CAD program with application specific purpose.

The work center described below realizes, by a block (A) of parallelepiped shape preferably of polystyrene foam EPS and/or extruded or other foam materials of the dimensions from the classic standard sizes of 400×100×120 cm or of other measures arranged in—a position vertical and/or inclined (the inventive machine can be built for the processing of special products in horizontal, and the block size (A) are not binding, because the machine can adapt to the dimensions of the block (A) built by the user, given that his inventive feature is also the ‘exclusive extensibility of the frame both in height, width and in length (figure not shown) with obvious replacement of the screws (or belt) of transmission (in the extending direction), the panels ICF variable geometry (in thickness, height and length), which artifacts are essential for the assembly of a formwork-base-slab formwork and related interposed the floor of any dimension (linear, angular, shaped with one or more cavities attached in any format or size they are.)

This inventive machine is characterized for the perfect cut, advantageously coplanar, and calibrated at the same time advantageously performs the milling of the panels ICF necessary for the construction of specific elements for foundations thermo-insulating capsule integral, hollow elements in EPS with geometry variable for multiple types of elements for linear or radial assemblage of stairs without the constraints of even the most complex geometries, internal and external walls, panels or slabs for floors, roofs, pitched roofs acoustic macro-ventilated micro-ventilated roofs, decorative elements such as monolithic, insulating sleeves for columns, hollow columns in the most diverse conformations for containment armor-’ and structural concrete, monolithic string courses with pits in the most diverse conformations for containment armor and structural concrete, cornices for containment armor and structural concrete in the most diverse shapes, decorative capitals in more diverse conformations for containment armor and structural concrete, insulation jambs for doors and windows, in the most varied shapes, armor for containment and isolation of structural concrete, in the most varied shapes, thermal seismic bins in the most diverse conformations acts to contain armor and isolation of structural concrete, round-headed arches insulation in the most diverse conformations acts to contain armor and insulation of structural concrete, and anything else necessary for the construction of buildings for private, public and industrial respectful of international standards ASTM.

The execution of the elements mentioned above, even in the most complex thickness and diameter, can be advantageously for steel rule cutting hot (single and multiple) linear and also shaped in many different shapes, hot-wire (single and multiple) linear and shaped milling and grading of articles made tools properly shaped for the purpose. The machining systems cited (hot cutting and milling) can succession sequentially or simultaneously, and always according to a sequence controlled by a numerical control (CNC) slaved to the inventive machine, in which are implemented the various processing cycles programmable via software of commerce or specific specifically designed for these features. The above and other objects and exclusive advantages of the invention, as will appear from the following description, are achieved with a pantograph machine accompanied, for example, cutting blades and dies hot and cutters or other special tools forming part of said invention conformed to ‘achieve the purpose, for the manufacture of panels, in particular panels ICF, with foamed materials or ‘extruded in general, as described in claim 1. Preferred embodiments and non-trivial variations of’ the present invention are the subject of the dependent claims.

It is understood that all of the appended claims form an integral part of the present description.

### BRIEF DESCRIPTION OF THE DRAWINGS

The present invention will be better described by some preferred embodiments, given as an example and not limitative, with reference to the accompanying drawings, in which:

FIGS. 1 to 11a illustrate a first variant of the Machining center of the present invention;

FIGS. 12 to 15a show a second variant of the Machining center of the present invention;

FIGS. 16 to 18 illustrate a third variant of the Machining center of the present invention;

FIGS. 19 to 21a illustrate a fourth variant of the Machining center of the present invention;

FIGS. 22 and 23 illustrate a fifth variant of the Machining center of the present invention;

FIGS. 24 to 27 show a sixth variant of the Machining center of the present invention;

FIGS. 28 to 30 illustrate a seventh variant of the Machining center of the present invention;

FIG. 31 illustrates an eighth variant of the Machining center of the present invention;

FIGS. 32 to ‘44 illustrate a solution with aggregate application—matrix—the work center block molding machine of the present invention;

FIG. 45 illustrates a variant of the Machining center of the present invention has at least one anthropomorphic robot equipped with specific tools suitable for the purpose forming an integral part of the invention.

### DETAILED DESCRIPTION OF REPRESENTATIVE EMBODIMENTS

Referring to the Figures, is illustrated and described a preferred embodiment of the pantograph machine equipped with blades by hot cutting and milling cutters, for processing of sheets, slabs, in particular panels ICF, with foamed materials or extruded in general, the present invention. Be immediately obvious that it will be possible to make what is described numerous variations and modifications (for example related to shape, design, sizes, thicknesses, heights, lengths arrangements and parts with equivalent functionality) without departing from the scope of the invention as it appears from the claims attached.

The work center described below produces quickly and easily, from a block of. parallelepiped shape, preferably of sintered polystyrene, also the size standard 400 centimeter×100×120 centimeter or other multiple measures (the size of the block or element to be work are not binding, because the machine (1) can be built in any size and/or adapted to the dimensions of the block or element found in the country in which it operates) components for the assembly of a mold (linear, angular, shaped), for the construction and assembly of all types of thermal insulation panels for on-grade foundations also complex geometry, walls thermo acoustic inner and outer panels or slabs for floors and acoustic, acoustic pitched roofs, roof ventilation thermo acoustic macro-, micro-ventilated. roofs thermo acoustic elements specific for foundations thermo-insulating capsule integral, hollow elements in EPS with variable geometry, for the multiple types of elements for the assemblages of linear scales or without radial constraints of even the most complex geometries, external and internal walls, panels or slabs for floors, sloped roofs, roofs acoustic macro-ventilated, decorative elements such as monolithic, insulating sleeves for columns, hollow columns in the most diverse conformations for containment armor and structural concrete, monolithic stringcourses cables in the most diverse conformations for containment armor and structural concrete, cornices for containment armor and structural concrete in the most diverse shapes, decorative capitals in the most diverse conformations for containment armor and structural concrete, insulation capsule jambs for doors and windows, in the most varied shapes, armor for containment and isolation of the structural concrete in. more diverse conformations, thermal seismic bins in the most diverse conformations acts to contain armor and insulation of structural concrete, round-headed arches insulation in the ‘most diverse conformations acts to contain armor and insulation of structural concrete, and whatever else is necessary for the realization models for ad hoc buildings monolithic and homogeneous hyper-insulated breathable, will be in private, public and industrial sectors.

Said manufactured articles obtained by this cutting process with the inventive machine, advantageously allow associating them and/or combining them between them being perfectly calibrated, for the creation of formwork shuttering ICF-sectional in site. Said articles and/or panels ICF thanks to the cavities obtained in the cutting process of the inventive machine, advantageously can integrate multiple types of special connectors, in containment integral, for example, of conventional steel rods, profiles of any nature.

The execution of the components, namely in particular the panels ICF described above, may take place by steel rule cutting heated (single and multiple without limitation conformation or integration of wire nickel cadmium as a basis sharp, linear and/or suitably shaped for the purpose, a heated wire (single and multiple, without limitation) linear and shaped, with one or more milling cutters and/or with electro-spindles, without limitation to obtain manufactured articles perfectly calibrated, the various systems mentioned machining (cutting through specific punches pre-shaped wire with embedded pre-shaped cutting edge as a base, and through specific milling cutters and/or electro-spindles suitable for this purpose) may succession sequentially or simultaneously, and always according to a sequence controlled by a numerical control (CNC) slaved to the machine (1) in which are implemented the various processing cycles pre-programmable and post-programmed for a simple and fast production of each type of artifact.

The descriptive part of the machine (1) inventive step that follows is broken down into components and related machining, for a better understanding of the unique versatility of the machine (1) itself.

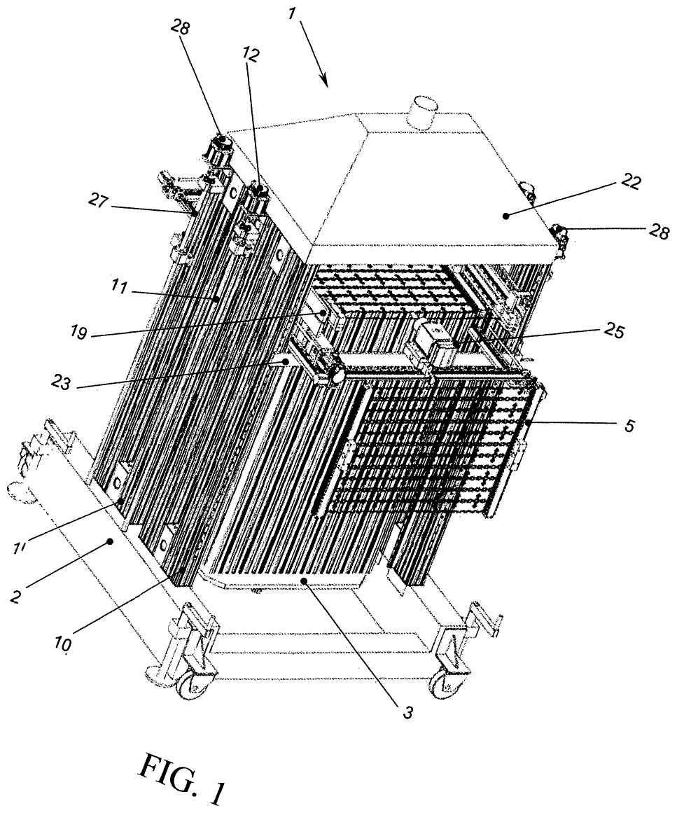

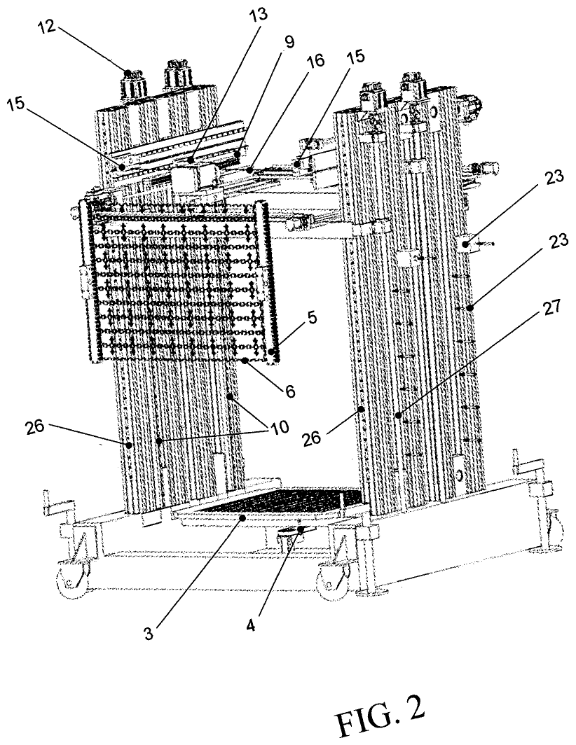

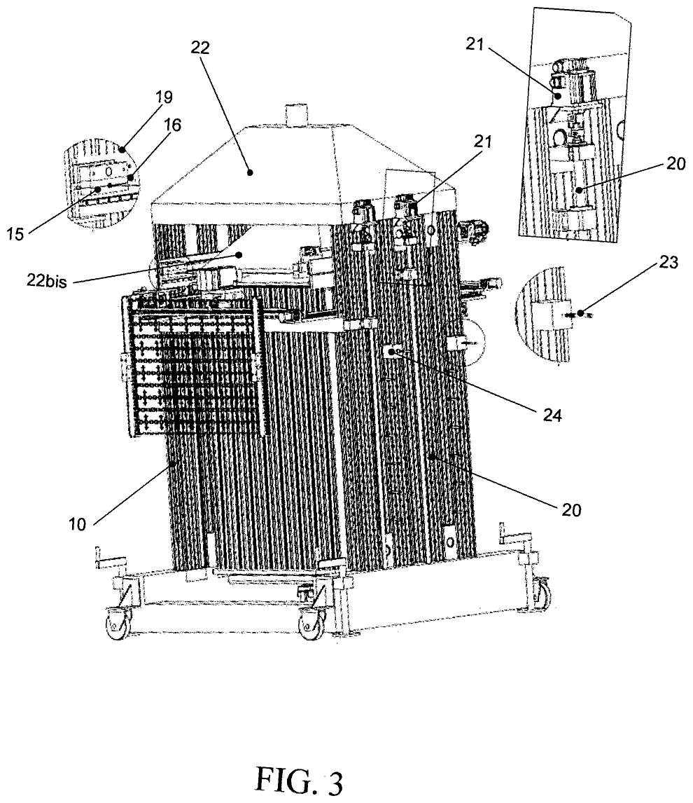

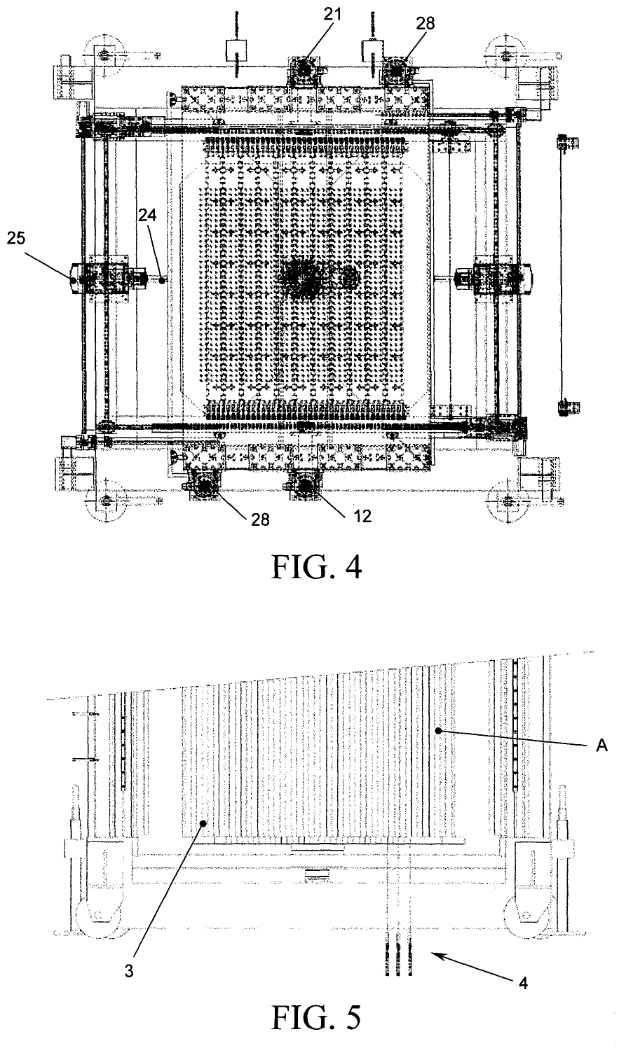

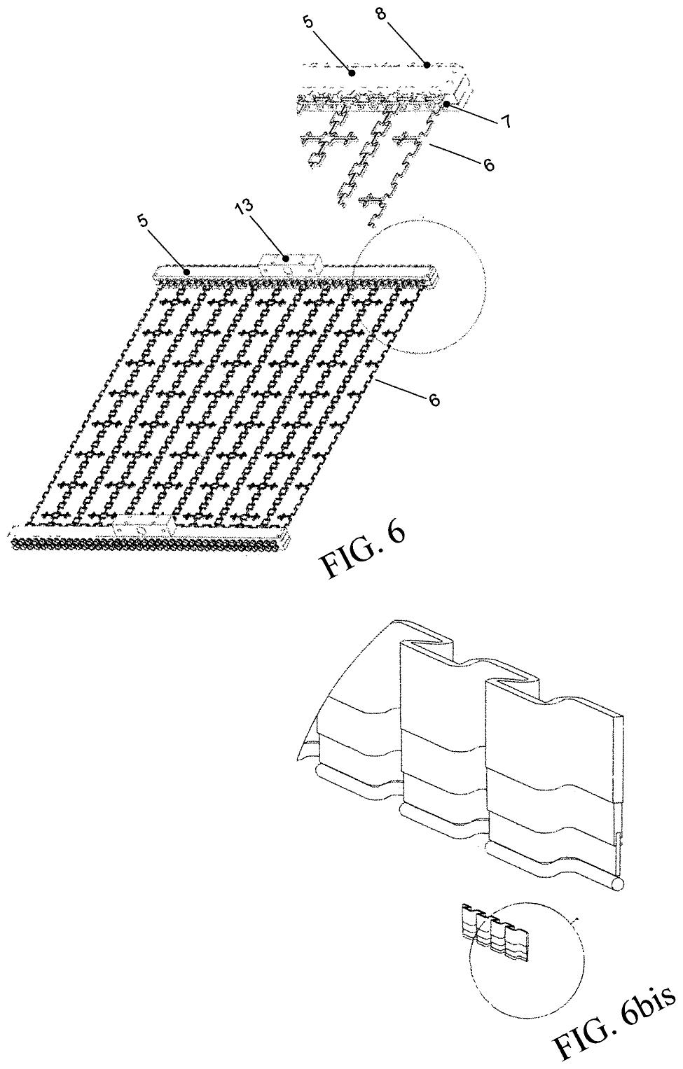

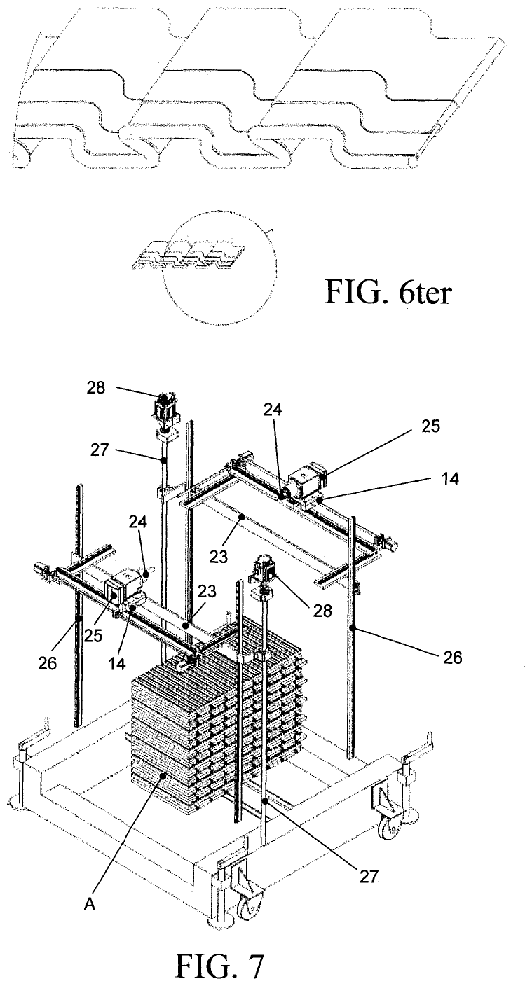

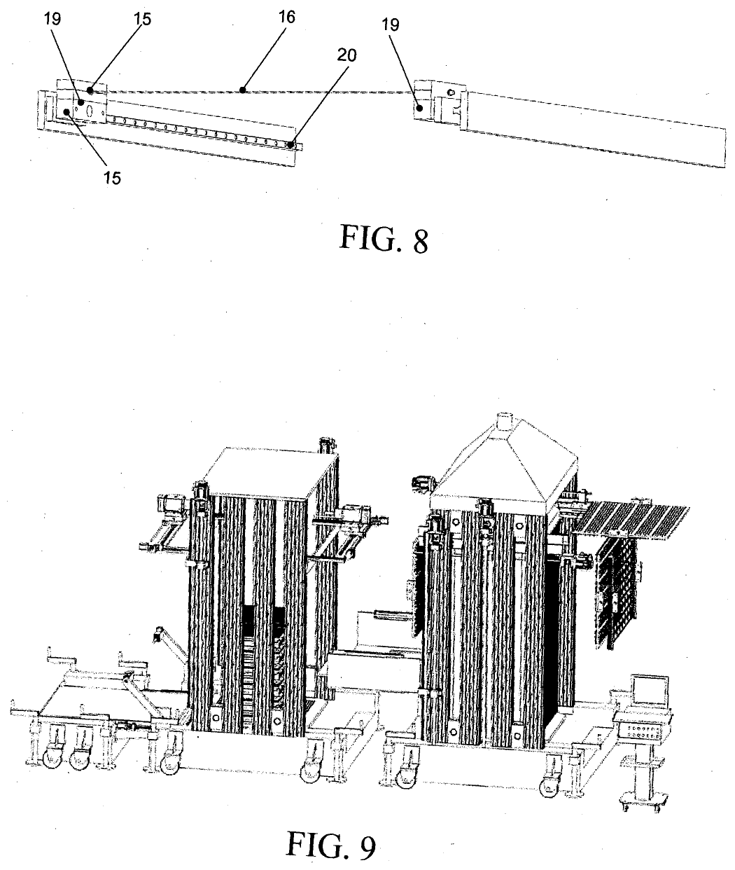

With reference to FIGS. 1 to 11 shows a first variant of the machine (1) of the invention.

Such a machine (1) allows the machining of a panel linear and perfectly calibrated. The panel has linear dimensions varying from a minimum of 120×15 (H)×5.0 and/or 7.5 (D) cm to 120×60 (H)×30 (P) according to multiples and submultiples of 15 centimeter for (H) and 2.5 cm and submultiples for (P) without limitation of other measures even if not multiple to each other. This panel presents grooves dovetail undercut and/or radiuses sides 120×H, linear grooves or polygonal alternate male-female (provided that dovetails may also be parallel to each other as-follows Male-Male-Female-female, but not limited to undercut radius and shape) on the sides 120×P, linear grooves alternate male and female sides H×D.

The inventive machine (1) for processing said panels ICF in EPS expanded polystyrene foam and/or other foamed materials, gummy of any nature and density, which are also recycled, polyurethane foam and others, consists of a castle (1′) to vertical uprights having grooves/longitudinal slots, supported by a base (2) which houses a supporting surface (3) equipped with electro-pneumatic cylinders (4).

The block of expanded polystyrene foam EPS and/or other foamed materials gummy, of any density, is also recycled, polyurethane foam and others without limitation (A), by means of a known carpet and/or a roller conveyor is placed in position plane (3) centered on the castle (1′). In the upper part of this, are placed various tools (punches linear and/or shaped, wires, drills and/or electro-spindles) in the order described below starting from the plan (3):
a frame (5) carrying cutting dies and steel blades (6) complete with specific insulators (7) and. devices (8) for fixing and tensioning adjustable (not shown) of the cutting dies linear or pre-shaped for the purpose. The dies can be fixed or mobile, to adapt to the thickness of the panel to be realized without limitation geometry. The frame-carrier carriage (9) slides on linear guides (10) of known construction, placed inside the uprights (1 and is moved vertically by means of a screw drive (11) (or also via a rack with pulleys and belt without limitation of motor mechanisms) and motor (12); on said carriage (9) is located a movement (analogous to 10-11-12) which allows the frame (5) to move in horizontal direction to escape easily from the castle (1′) so as to be positioned mechanically and/or manually according to an angle from 0° to 90° due to a specific hinge graduated in millimeter (13) interposed between the carriage (9) and the frame (5) to make the cut according to directions at will and without restriction. Above the cutting dies, are placed metal devices (not shown) having the same shape of the dies, which prevent the narrowing of the cut immediately after the passage of the die itself which is linear or pre-specific fitting in order to prevent an increase of the friction and. resistance to cutting and any deviations if even minimum of the same.
Two slides (23) for milling performed by a tool (24) mounted on an electro-spindle (25) placed on a carriage (14). The slides (23) opposing slide on linear guides (26) of known construction placed outside of the uprights (1′) and are moved vertically by means of a screw drive (27) (or also with rack (not shown) pulleys and belt) and motor (28); on these slides (23) is placed a handling (skates, screw, motor, similar to 26-27-28) that allows the displacement of the step necessary for the realization of the grooves. Can be mounted to each slide more than one electro-spindle to perform milling-specific contemporaneous.
A frame (15) carries wire/s (16) complete with insulators (17) and devices (18) for fixing and tensioning wires. The wires can be fixed or movable to adapt to the specific cutting to be performed without restriction. The carriage (19) carrying frames (15) slides on the linear guides (10) used for moving the carriage (9) and is moved vertically by means of a screw drive (20) (or also with pulleys and belt, without limitation) and motor (21); on said carriage (19) is placed a handling (analogous to 10-20-21) which allows the frame (15) to move in the horizontal direction to make the cut at desired heights, preferably measures in both multiple and submultiples, but. not limited to other measures. Since the machine (1) enslaved by system CNC, the wire/s (16) can move in an interpolation according to the vertical and horizontal directions so as to perform an inclined cut without limitation of gradation and/or according to a specific curvilinear profile.

Using a single wire (16), the cutting operation. in horizontal begins as soon as the frame-dies carriers has exceeded the safety altitude (controlled by control equipment to laser-photocells of known construction) and have been performed by the grooves cutters.

As previously mentioned, the block in EPS polystyrene foam or other foam materials or gummy of any density, albeit recycled, such as polyurethane foam and other insulating materials of any nature, rests on a board (3) equipped with electro-pneumatic cylinders (4) load-bearing rod end a sphere self-supporting. The latter, activated by CNC depending on the format of the panels to work in production,’ protrude from the table (3) and rise as the blocking in EPS polystyrene so that—the frame (5) carrying punches (6) can escape completely from said block at the end of the vertical cut.

The table (3) can be equipped with rotary motion about its axis; fact, in the execution of assailable elements to a cylinder (hollow columns for pillars in many different forms, shuttering/formwork for pillars, bins thermal), once effected cutting with the cutting dies/punches hot, you may need to make specific milling with predetermined angles to perform with electro-spindle (25).

For the maintenance of the panels ICF cut on the sides of the castle (1′) opposite the entry and exit of the block in EPS polystyrene foam, are arranged in the vertical direction of the electro-pneumatic cylinders equipped end of the stem of pointy appendages (23) or suction cups (24), which intervene constraining the element actuated by the CNC only after the passage of the frame” (5) carries cutting dies-punches (6), and are deactivated returning back at the end of all the processes.

Starting from the top, the panels which are completely machined can be evacuated from the work area through the gripping devices, described subsequently, combined with the machine (1) and operated by the same CNC.

In the upper part of the castle (1′), are placed a suction hood (22) of the fumes generated by the cutting die and wire and against a hood (22a) for maintaining the cutting temperature.

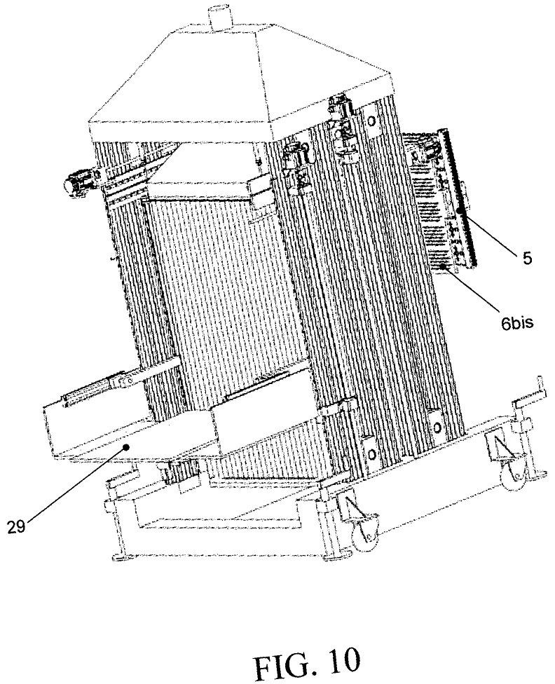

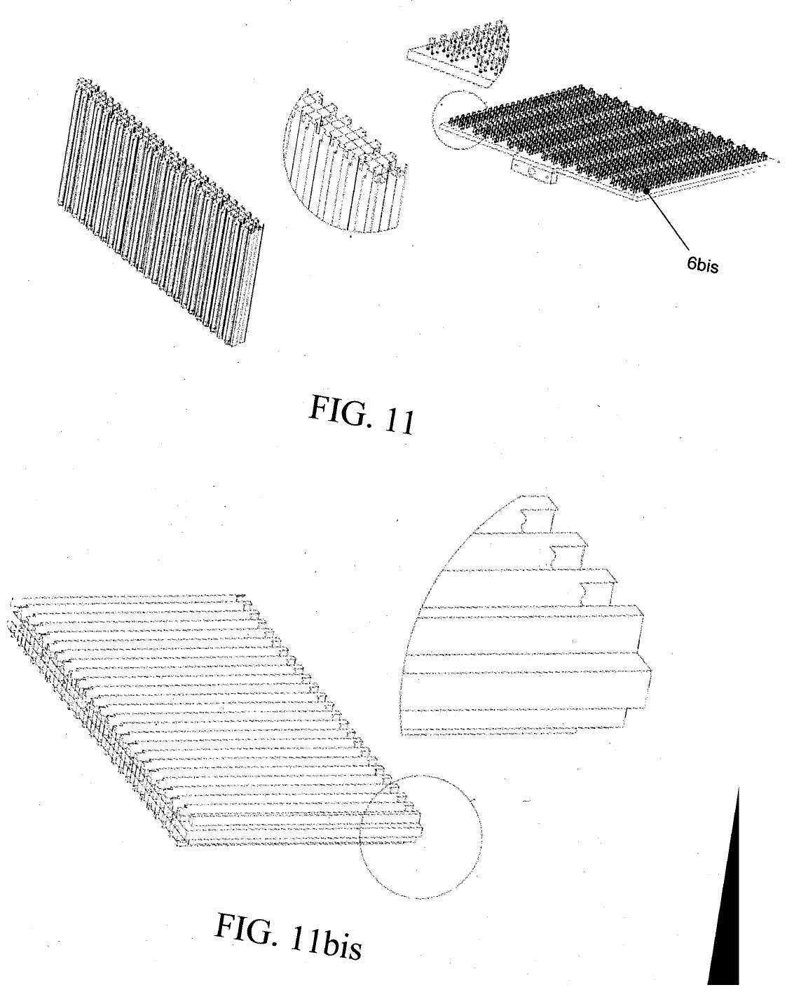

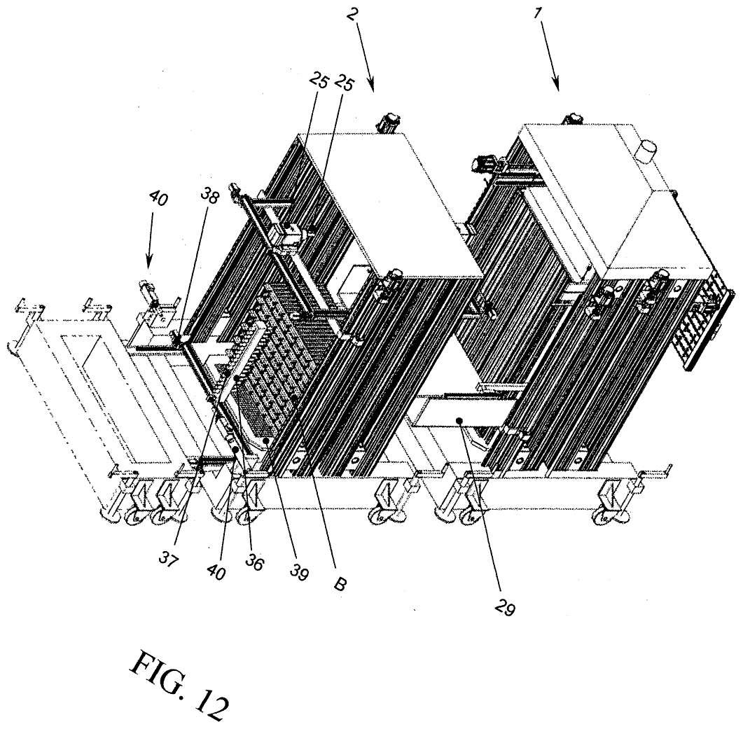

A different construction of the machine (1) is illustrated in FIG. 10, where there are mounted devices cutter, but on the same kinematic motion is mounted to, a frame-dies carrier equal to the frame (5); the die (6) can be equal to that described above to create the grooves a horizontal, shaped to create quarries, grooves even the most disparate and/swing without limitation (FIG. 11a) or may be a multiple die (6 bis), to create with controlled movements. by CNC the conformation checkerboard indicated in FIG. 11.

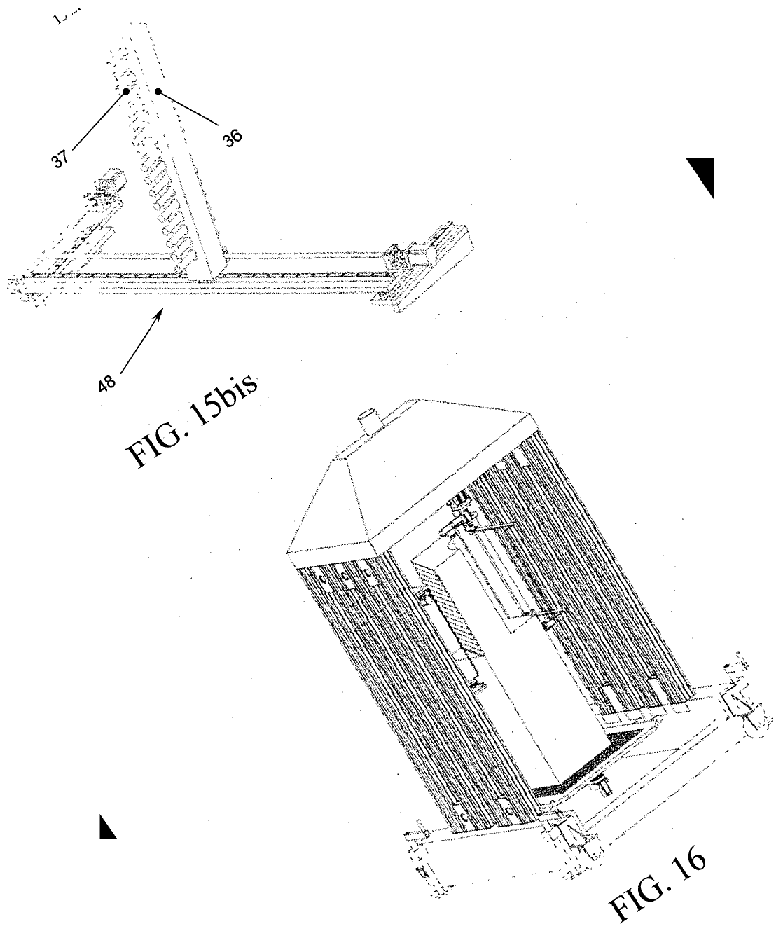

With reference to FIGS. 12, 13, 14, 15, 15a, while it is clear from the foregoing description that the end panels ICF products, ie processed, are missing on the sides of the grooves 120×P and P×H, in order to obtain the complete realization of the block, from the first station is removed the milling unit (23, 24, 25) and on the same his kinematic motion (26, 27, 28) is applied to a translation mechanism and tilting (29), by means of. which the group of panels ICF is brought into a second station (30) where, through the mechanisms of milling (30) and (31), said panels undergo the execution of the grooves on the sides 120×D.

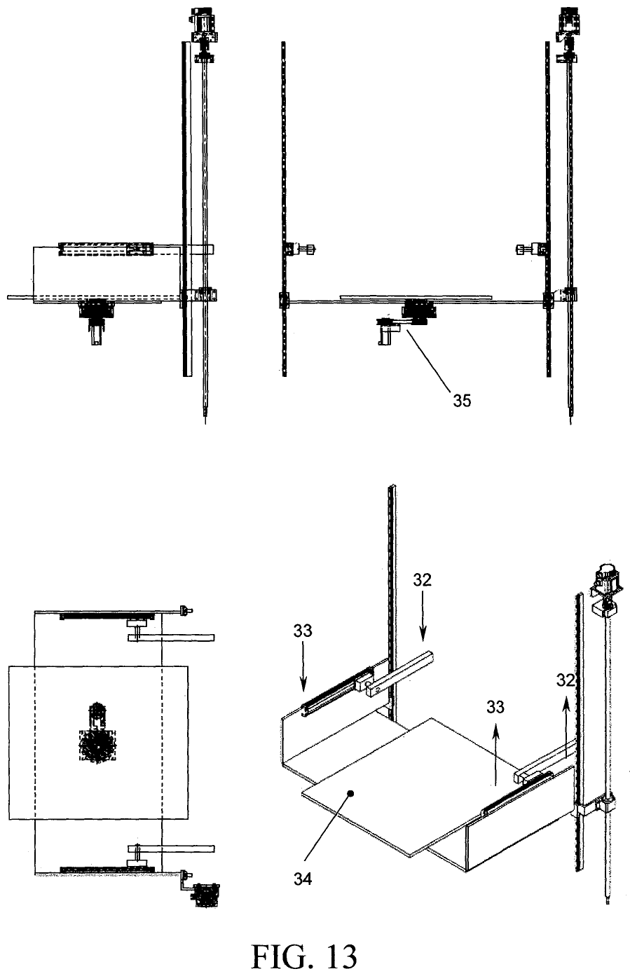

The translation mechanism and tilting (29) shown schematically in FIG. 13 is composed of two metal arms with applied shoes and/or suction cups (32) which run in the gripping position by means of pneumatic cylinders (33), which, by exerting a pressure on the group of panels ICF to be extracted by means of pneumatic cylinders (not shown in the drawing), perform the overturning of 900 of the said group and place it always with the cylinders (33) in the second station.

The metal arms (32) can, depending on the working cycle, release the group of panels ICF on the table (34) which can rotate by means of a geared motor (35), resume the group of panels ICF and deposit the second station.

Execution of machining operations on the sides D×H provides a support (36) port—electro spindles (37) arranged vertically with variation motorized mechanical and/or manual distance between the one and the other (known mechanism consists of the adjusting screw with bolts and locking), moved by the kinematics (38) always consists of specific rails, screw and motor (similar to devices 26-27-28). This kinematic system is illustrated on the drawing only in the direction parallel to the group of panels ICF B for simplicity, but in reality the kinematic mechanism is also present in the orthogonal direction (kinematic cross) for the evacuation from the working area when it is in action at least a milling cutter (24), for the approach to the group of panels ICF and the evacuation for the passage of the group itself machining has been completed. Being the station (2) equipped with a rotary table (39) analogous to (3) [including devices (4)], the milling operation, on one side P×H, subsequently, after having carried out the rotation of the table (39), repeats the processing on the other side P×H.

Milling operations performed by the devices 36-37 can also be obtained with the kinematic mechanisms (40) shown schematically in FIGS. 12, 14 and 15. It is electro-spindles (41) mounted on arms (42) which rotate by means of motors (not shown) applied on the support (43); devices (40) are mounted kinematic cross (rail, screw motor) similar to those described above for the movement in the longitudinal direction and transverse direction.

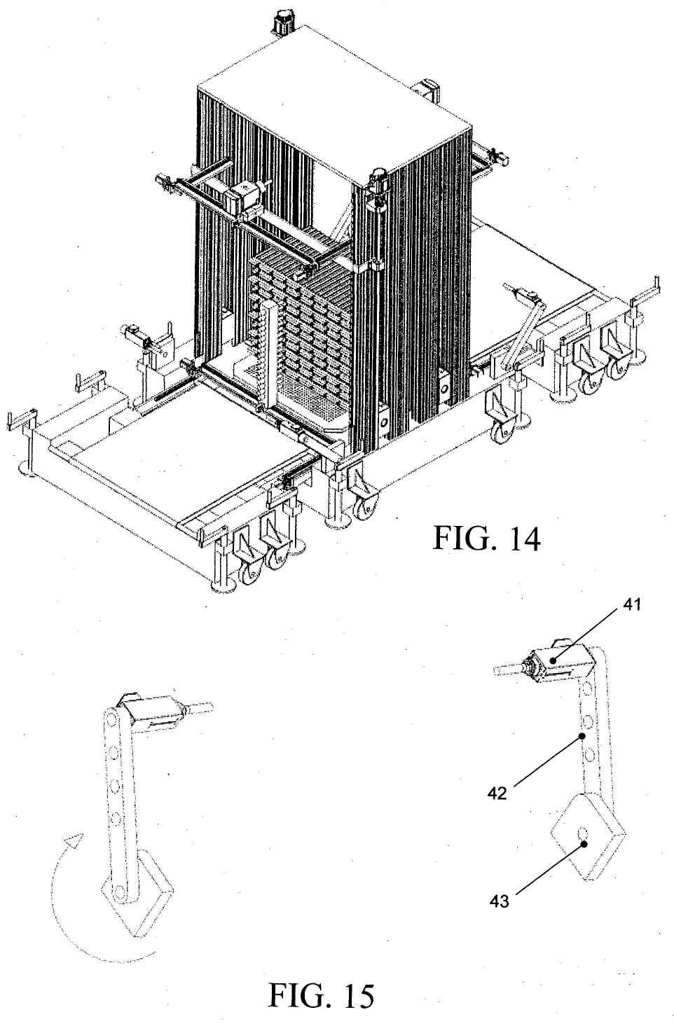

In FIG. 14 there is shown a configuration that includes carpets and/or roller conveyors notes feeding and rotating arms upstream and downstream.

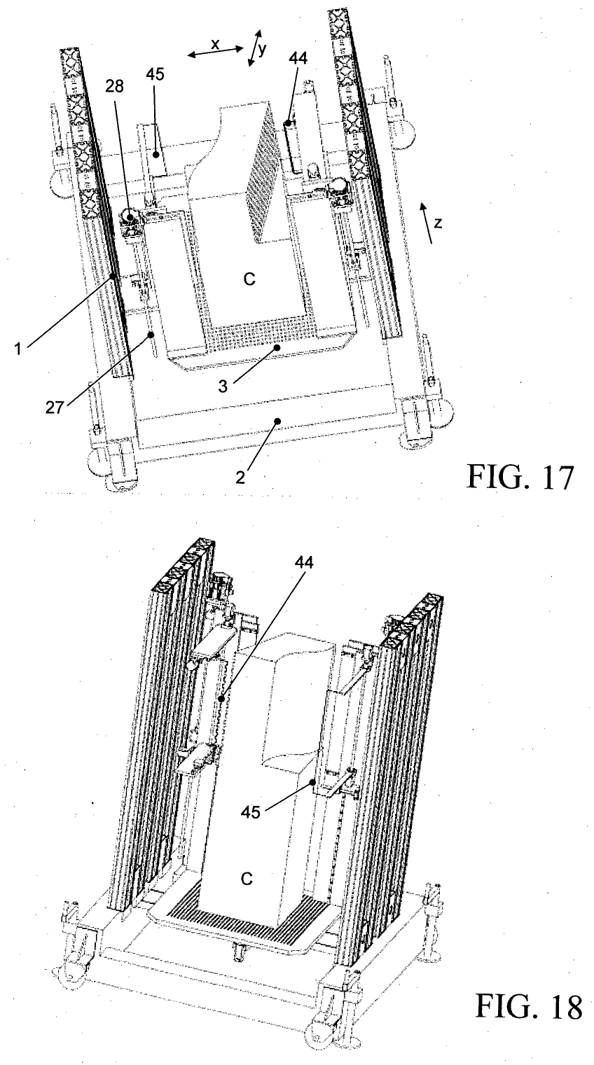

With reference to FIGS. 16, 17, 18, there, is illustrated a variant of the machine (1) inventive configured for the machining of monolithic decorative cornices having quarries, obtained from block in EPS. (C). The machine is constituted by the same castle (1′), base (2), rotary table complete (3-4) on which by means of the same kinematic mechanisms described above (and consist of rails, screws and motors type 26, 27, 28) is obtained by the movement of the dies (44) and the wire (45), in order to obtain the decorative shape, without limitation of said decorative cornice in a facade and the dovetail grooves for the engagement of the connectors from ‘other. The execution of the monolithic decorative cornice over the entire length of the block in EPS is carried out in steps, depending on the length of the cutting dies/wire and for this, in addition to the movement in X. and Y, is implemented a handling (always similar to those described above) also in the direction Z. The rotary table (3) allows to orient the block of expanded polystyrene or other foam materials and chewy, any density, even if recycled as polyurethane foam and other at will, all these movements are controlled by the CNC.

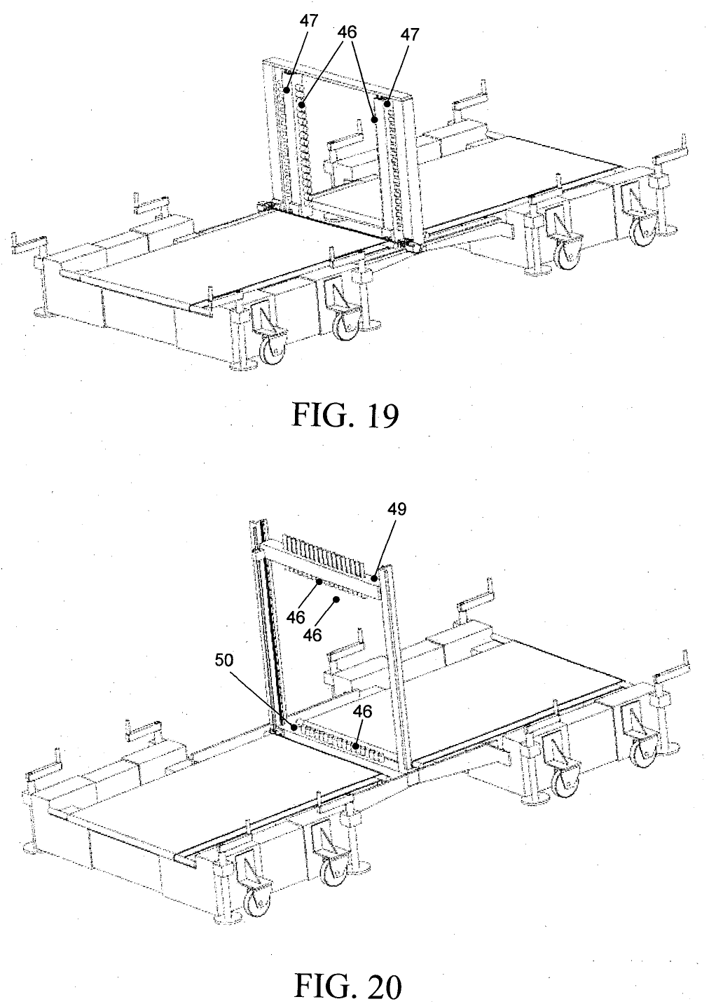

With reference to FIGS. 19, 20, 21, 21a, is shown a variant of the machine (1) inventive configured for the processing of blocks or groups of panels ICF through a series of cutters (46) mounted on a support (47), the all mounted on a frame (48), moved by means of the same kinematic mechanisms described above (and consist of rails, screws and motors type 26, 27, 28).

On the supports (47-49-50) port electro-spindles (46), the position of the latter can be fixed or can be varied mechanically and/or manually in distance between the one and the other (known mechanism, consisting of adjusting screw and locking by means of bolts).

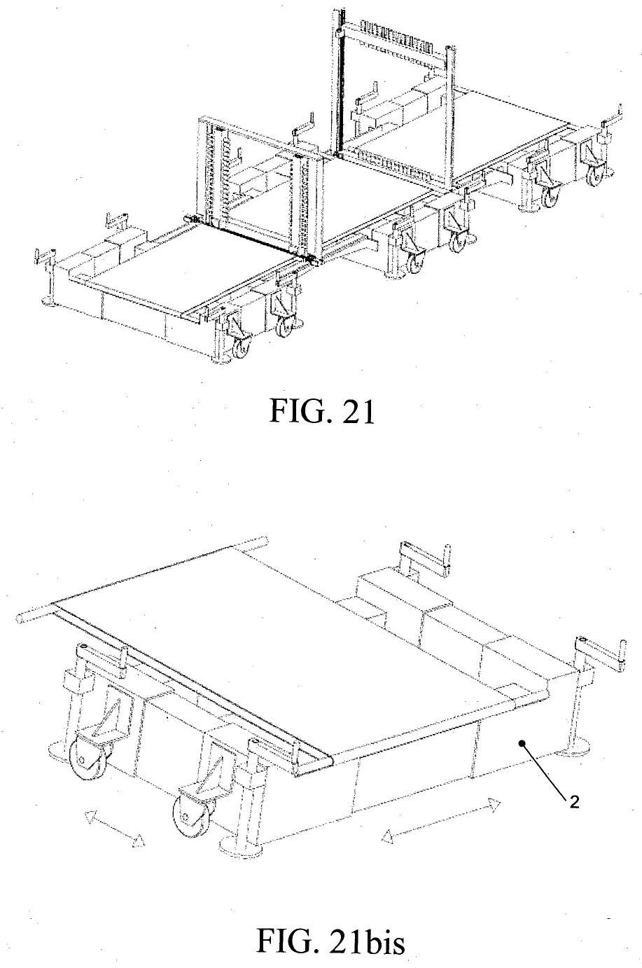

In FIG. 19, the movement of the frame (48) is along the axis of carpets and/or roller conveyors notes, while the movement of the supports (47) is towards the center-of the tape. In FIG. 20, the movement of the frame (48) is along the axis of carpets and/or roller conveyors, the upper support (49) moves vertically while the lower support (50) has no vertical movement. In FIG. 21, the two configurations are represented one after the other. In FIG. 20a, there is shown a variant of the base (2) manually expandable in length and width by means of screw mechanisms known (not shown).

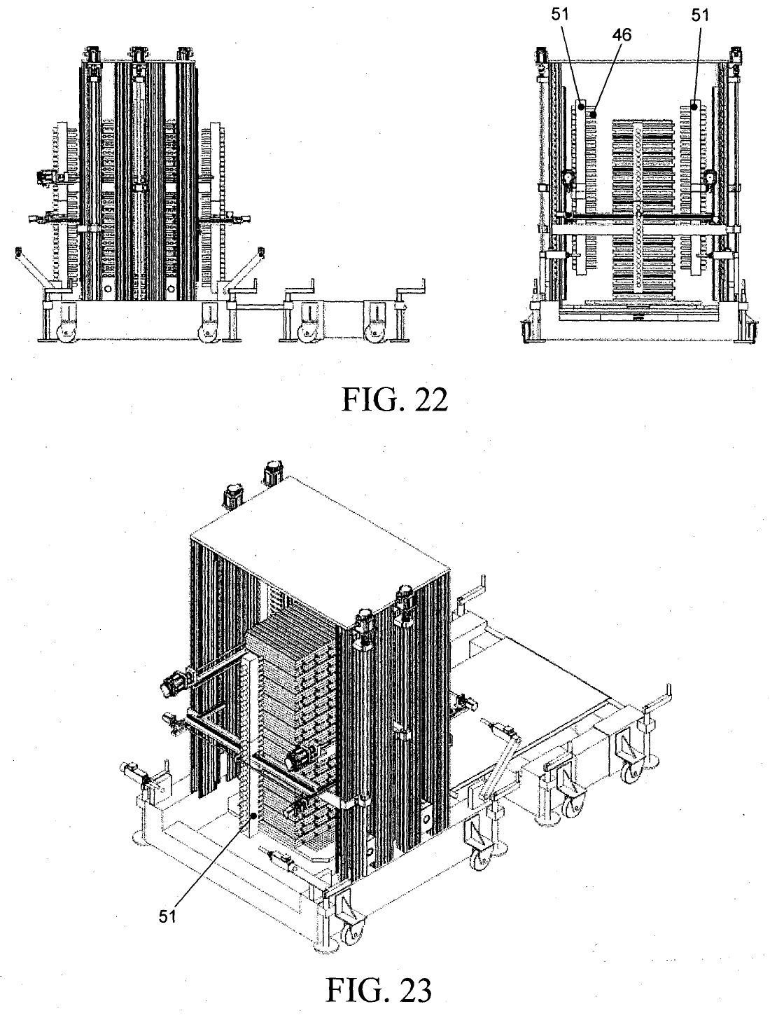

With reference to FIGS. 22 and 23, there is illustrated another variant of the machine (1) inventive, configured for the machining of hollow blocks, thermal ant seismic box or groups of panels ICF through a series of cutters (46) mounted on a support (51) moved by means of the same kinematic mechanisms described above (and consist of rails, screws and motors type 26, 27, 28). On the support (51) carries electro-spindles (46), the position of the latter can be fixed, or can be varied mechanically and/or manually in distance between the one and the other (known mechanism consists of the adjusting screw and by locking bolts). The machine (1) can be mounted at least one support (51) for each side.

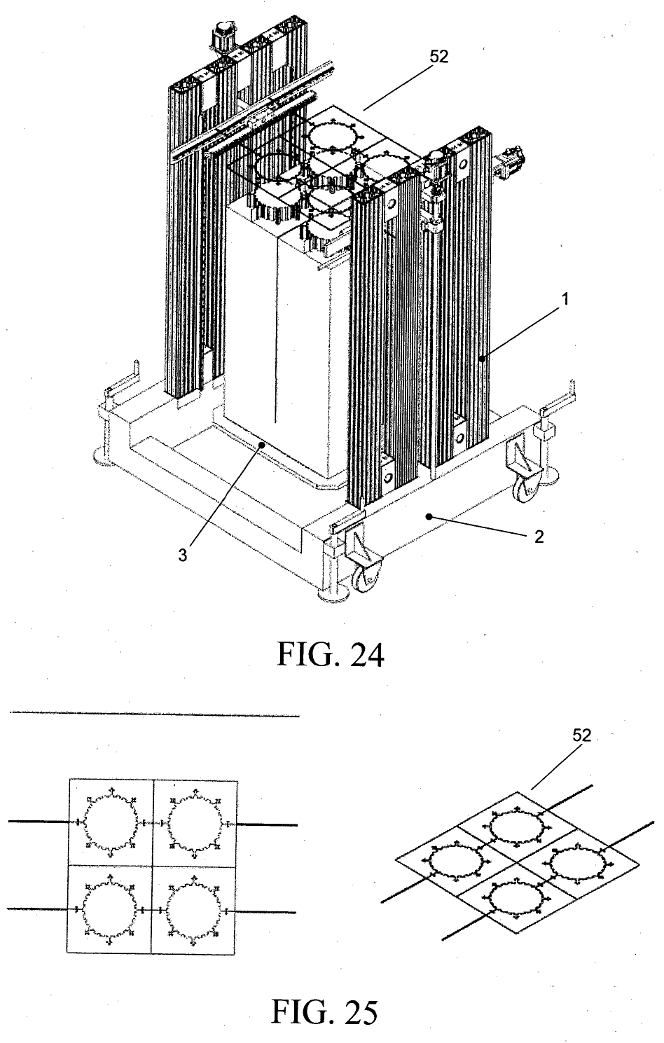

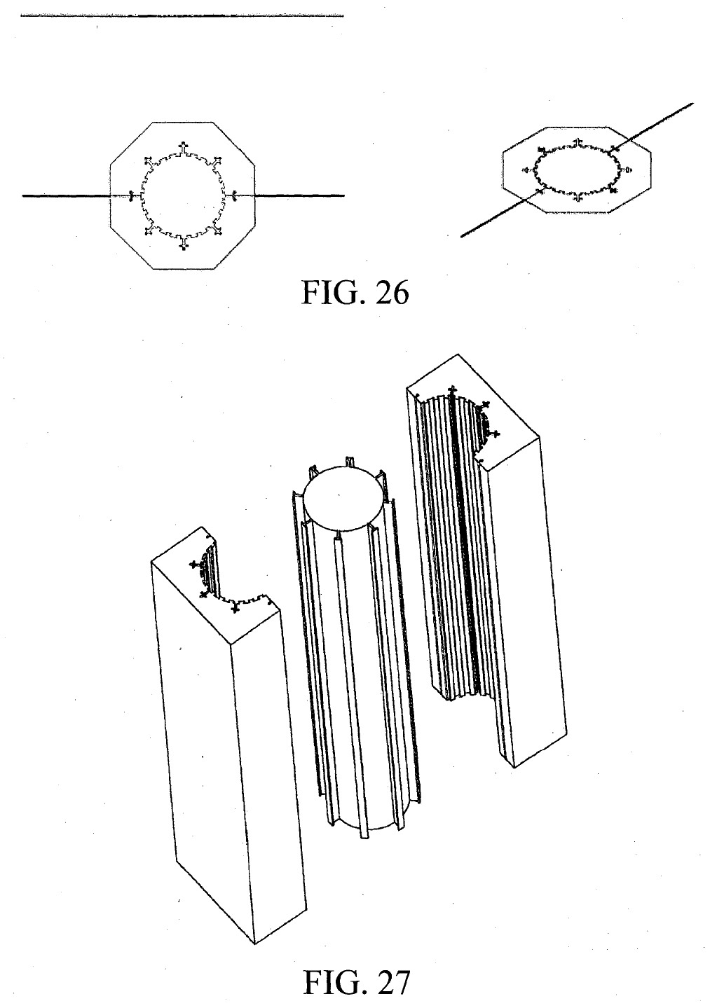

With reference to FIGS. 24, 25, 26, 27, is illustrated another variant of the machine (1) inventive, configured only with kinematic cutting dies for the realization of multiple columns and semi columns with the most diverse conformations without bond indeed including emptying configuration with the inner face of the same column above or siphon with dovetails and appropriate locations for housing spacers and connectors, acts to bind brackets and steel bars, which also extended elements of any shape and form of the materials even the most disparate. The machine is the basic version described at the beginning (base 2, castle 1′, rotary table 3-4) where the multiple die (52), through the movements already described above, descends vertically to create and conform bins thermal and also the columns and/or semi emptied adapted to receive as described above.

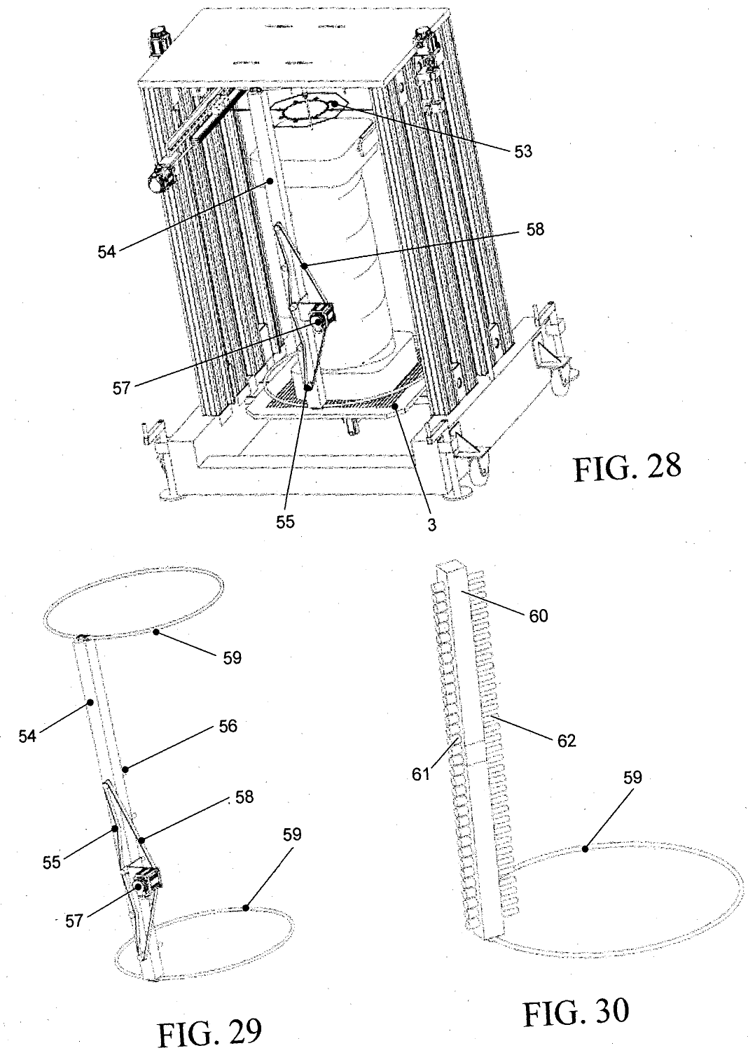

With reference to FIGS. 28, 29 and 30, there is illustrated another variant of the machine (1) inventive, with only kinematic cutting multiple punches (53) for the realization of semi-columns, including their emptying as described above. On the machine (1) can be implemented:
A support (54) bearing spindles (55) Cutter holder (56) at a variable distance between manually and mechanically fastened with bolts. The mandrels are placed in rotation by a variable frequency motor (57) and a belt (58). All the kinematic mechanism may be in a fixed position and in that case the work piece wheel by means of the rotary table (3), or also itself rotates on circular guides (59) by means of motor, pinion and rack, not shown;
a support (60) carrying more electro-spindles (61) carrying cutters (62), always in wheelbase and available variables as described above; entire kinematic mechanism may be in a fixed position, and in that case the work piece wheel by means of the rotary table (3), or also itself rotates on circular guides (59) by means of motor, pinion and rack, not shown.

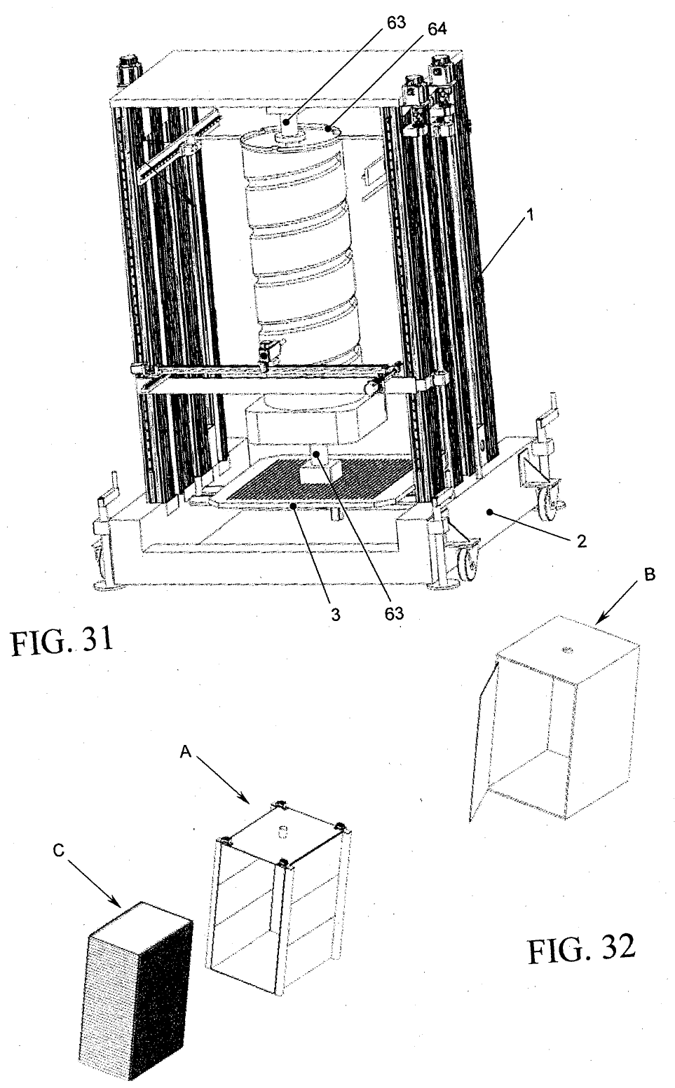

With reference to FIG. 31, there is illustrated another variant of the machine (1) for the inventive turning of the columns or half-columns, suitable to obtain the desired shape, also the most disparate without bond. The machine is constituted by the. same castle (1′), base (2) and rotary table complete (3-4). The column is mounted between a sprocket (63) in conical tips fixed to the rotary table (3), which takes advantage of the movement, and another feeder (63), mounted in the upper part of the castle (1′), slide vertically by means of a device in pneumatic cylinder (not shown) to adapt to variations in height, even the most disparate. Dragging can also be obtained with a device lamellar hot (64) which penetrates into the material (also interiorly disposed in a fixed position, but not visible) moved in height from the usual systems already described.

As regards the application software that manages the machine (1) inventive, is meant by this term a CAD-CAM to be installed directly on the server Machine (1) and/or in a workstation external and networked with the aforesaid server, and in any case remotely connected with the principal place of business.

The supervision software and compiler working on operating system MS-DOS (but also in a window of Windows) and you can replace the PC with any one and′ in no time or even perform the supervision software from floppy disk.

There are at least a CD-ROM with all the back-up system (source, compiler, supervisor and utility) but also an emergency floppy disk, able to reboot and supervision on any PC with a floppy disk and a RS232 serial port. You have the option to connect a second PC where immediately install all the “system.”

The 2D/3D CAD is implemented in an application specific structured as follows:
Proprietary database of all the elements producible enabled storage only authorized files cannot be modified by the user, but it can be called with prior approval (headquarters) for the production. Each new creation desired by the user where to be submitted to the authorization of a data processing center in remote connection, viewing the drawing; you can create a specific program suitable for the purpose of manufacturing multiple types of products.
Nesting algorithm that allows, given the size of the block to be processed and the type of the element (and/or elements provided, they are compatible with one another for tools) to be realized, the optimization of the material by reducing waste to. a minimum.
Automatic generation of the cycle understood as a sequence of operations to be performed and the tool path.
Visualization and monitoring of the various phases of work.
Monitoring and parts counting performed, since the latter cannot be altered by the user if not using alphanumeric password changed automatically.

The machine (1) inventive step can advantageously be transported through a specific transport system (not shown).

On the base of the Machine (1) are arranged (by screwing or welding) devices to cylindrical or polygonal hole for insertion of gripping of an arm, which moves by means of hydraulic cylinders on a trailer. Once inserted the gripping, by means of the hydraulic cylinder, the machine (1) undergoes a rotation of 90°, so as not to exceed the maximum overall height of 4 meters. Subsequently, by means of the cylinder, the Machine is moved so as to fall in the shape of the trailer.

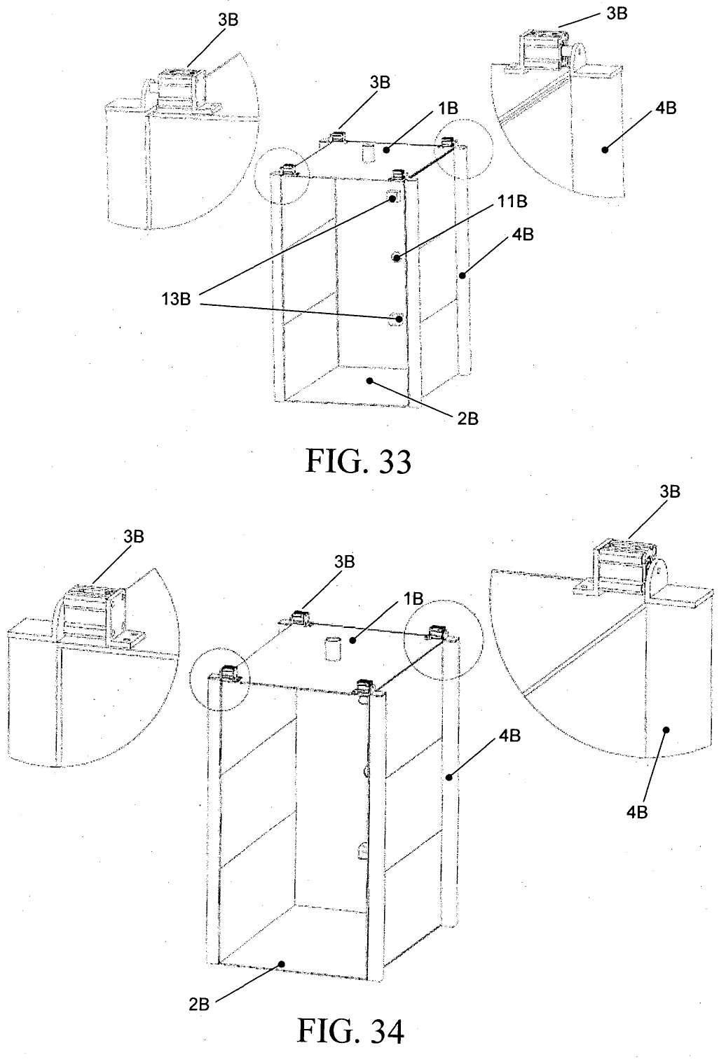

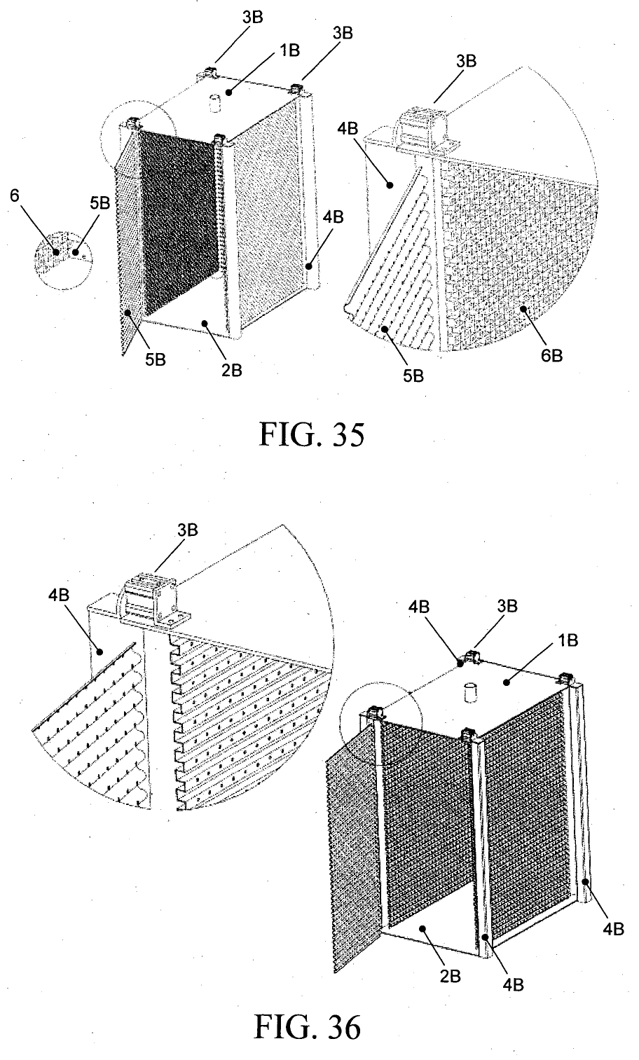

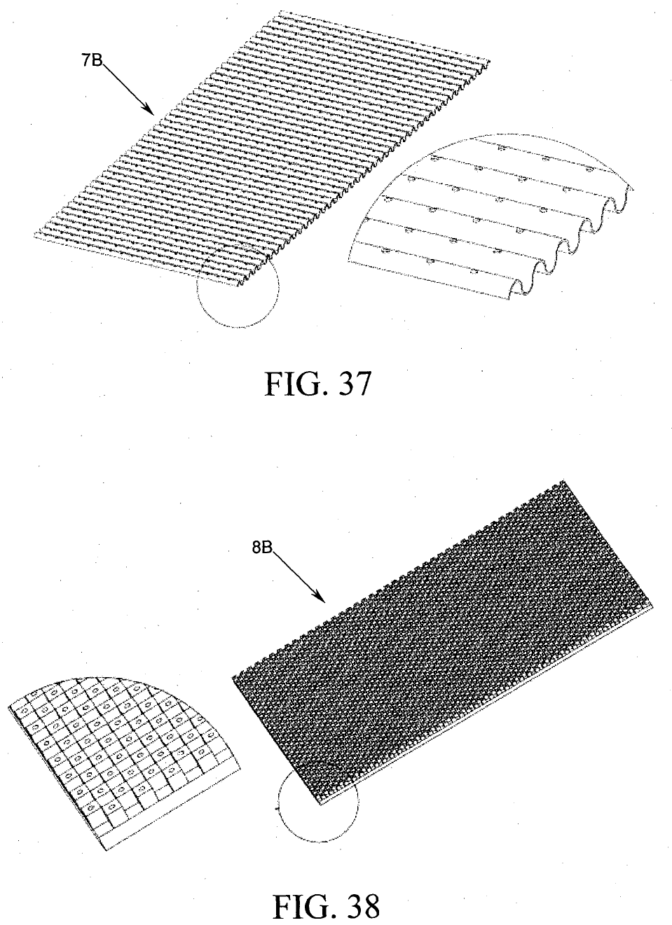

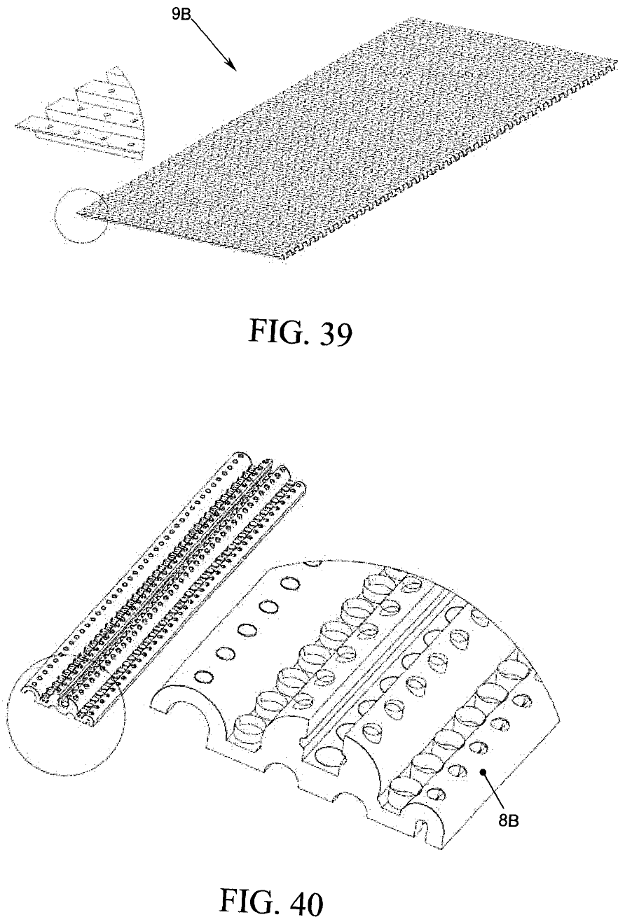

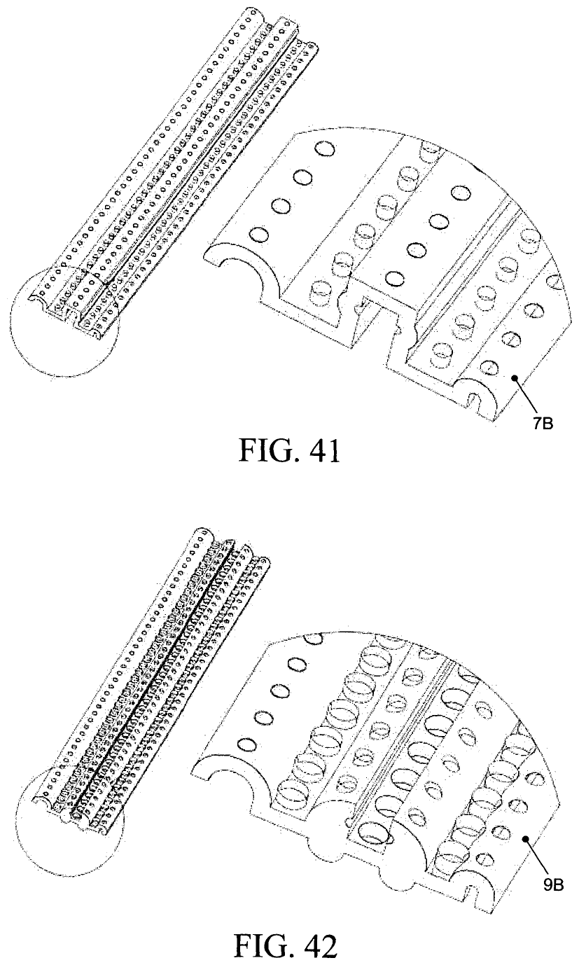

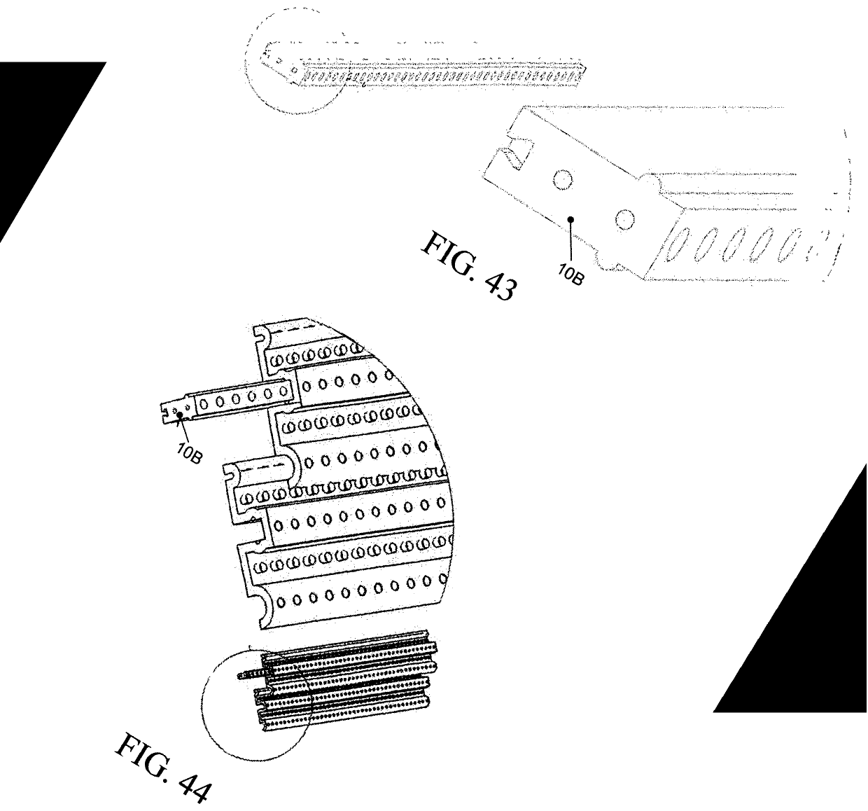

With reference to FIGS. 32 to 44, there is illustrated an application of matrices in. a block machine relative to the machine (1) inventive. It is a structure (A) to be inserted inside a concrete block (B) for the execution of parallelepiped blocks in EPS polystyrene pre-profiled (C). The structure consists of an upper frame (IB) and by a lower frame (2B), which are bound and perfectly anchored to the concrete block (B) with known mechanical fasteners (not shown), by two frames (4B) movable by means of hydraulic cylinders (4B), by shaped sides (6B) mechanically fastened on the bottom and on the door of the block machine (B) and by shaped sides (6B) mechanically fastened to the side frames (4B). On each of the frames (IB and 2B), are fixed four or more hydraulic cylinders (3B) (represented only in the upper part) that ensure the opening of the side frames (4B) so as to permit easy extraction of the parallelepiped block in EPS (C) once formed, and sintered. The sides (5B-6B) can have various configurations and types of construction; in FIGS. 37-39, there is shown a construction performed with bending (7B-9B), in FIG. 38, there is shown a construction performed with milling (8B), but both monolithic. In FIGS. 40, 41, 42, 43, are represented shaped modular elements obtained by milling; these modules can be coupled to and interlocking are attached and bound to the cross members (10B) which in turn are fixed to the bottom and the. door of the block making machine and side frames furniture (4B) of the aggregate. It ‘clear that, in correspondence of the mouths of the steam outlet (11B), the introduction of the polymer (12B) and extractors (13B) of the block EPS, the surfaces of the matrices are interrupted order not to hinder the functionality of the block molding machine.

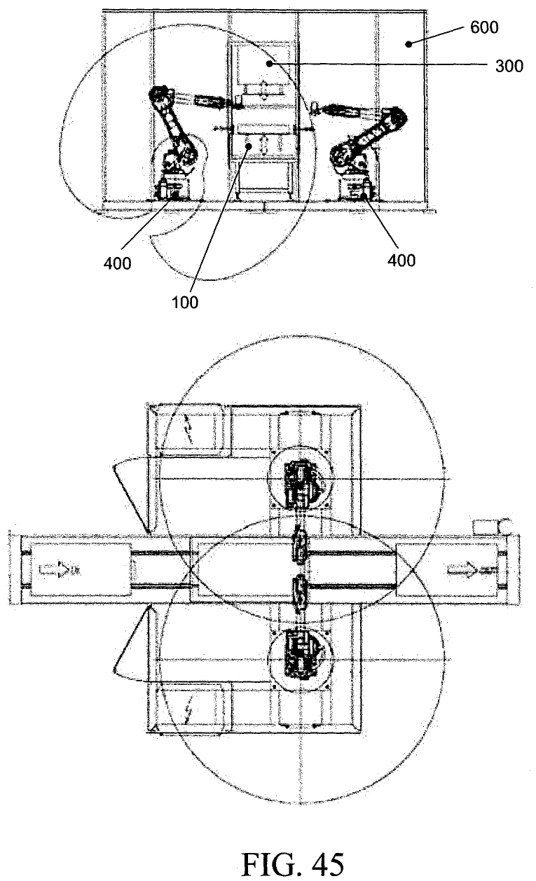

Finally, with reference to FIG. 45, there is illustrated a specific cell with integrated anthropomorphic robots. This is a work center for the machining of shaped cutter from a sheet of various thicknesses in EPS polystyrene foam or other foam materials or gummy of any density, albeit recycled as polyurethane foam and other consisting’ of:
At least one support surface (100) of the blank, adjustable in height with kinematic screw and motor to adapt to the size of the piece itself;
At least one centering device (200) of the work, piece relative to the axis of the support surface (100), realized-with bars actuated by pneumatic cylinders (not shown);
At least one counter-surface (300) actuated by a pneumatic cylinder (not shown), operating at low pressure for clamping the work piece;
At least two robots (400) bearing in the wrist at least one electro-spindle (500) carrying cutters for the machining of the work piece in any direction, even the most disparate;
At least one protective cab for operator safety.

The use of at least two robots (400) suitably customized with special mandrels (500) on which are fixed to the wrist articulated suitable cutters (600) suitable for the purpose, guarantees the processing of blocks without bond, slabs, panels ICF, elements decorative cornices, string courses, roller-shutter door thermal, etc. This solution allows carrying out the milling of at least two long sides of the panel and, with simple programming, to perform additional millings in the direction or inclination completely different from each other. The operating cycle provides that the panels conveyed via a carpet and/or roller conveyor known, within the cell, they are centered with the device (200) and blocked automatically by the presser plane (300) on the support' surface (100); a simple zero authorizes the life-cycle at the same time the two robots. At the end of milling the panel or decorative element is released on a removal conveyor belt (not shown), invoking a second panel always transported by means of a carpet and/or roller conveyor, not shown. The cell is completely enclosed in a protective structure consists of transparent panels in shatterproof material, assembled on a metal frame or aluminum and interlocked doors. A suitable vacuum system provides the evacuation of the chip in a specific collection tank. All the operation of the cell is controlled by a numerical control (CNC) which is accommodated in the cupboard door electrical wiring (700); specific software allows the management of the drawings and their transformation into tool paths which will be executed by the two robots individually or simultaneously depending on the conformation and the shape, even the most disparate, the piece to be performed.

As far as the technological-productive flexibility, the advantages are so numerous that the list can only be schematic:
the perfect features of selected aluminum alloys, and especially of alloys for High Speed Milling (without imposing change frequently because of the modular matrices durable).
consumption by abrasion of hard materials sintered (Sintered) and the same rectangular blocks tending to zero (compared to working on steel sides)
almost total elimination of slow processes such as arthritis that are created during the ejection of the block (A) in EPS parallelepiped block molding machine by vertical or horizontal
simplification of the budget and determined application of matrices micro-perforate “molds and figures” (only or mainly to scroll through the strips connected to the steel walls of the conventional block molding machine)
reduced energy consumption,
Implementation actual production (without interruption) molding without interruption for cooling
In general, significant increase in the speed of preparation of the counter-mold (made of micro modular aluminum) to be inserted into the mold of a conventional rectangular block molding machine
advantages in terms of speed of. construction, all the more remarkable, the higher is the volume of the counter-mold and the volume to be removed by conventional milling (construction of “molds”)
troubleshooting cooling and related circuitry in an easy way: in fact, the same circuit is passing through the cavity of the strips attached horizontally to the wall of the conventional block machine, which in turn engage solidly in aluminum micro-perforated sheet metal of the matrix, where for many steels this is impossible (steel molds for more “insulation”)
drastic reduction of time adjustment (due to lower bending stresses induced in the molding system of rectangular blocks in innovative EPS)
drastic reduction of the time required for the surface polishing of the innovative against micro-perforated matrices, both manual or HSM.

The advantages compared to traditional systems are considerable:
small size of installation,
low noise level,
complete absence of dust in the waste may therefore be recovered,
reduced energy consumption,
lower capital investment for the production site and at a fixed location of the plates depicting dovetails and slots for receiving spacers/connectors in general,
considerable operational flexibility: the profile of the quarries and the flare, tapping, and the thickness of the plates will be programmed by software applied to a PC without having to replace and/or change any tools.

The same block (A) parallelepiped expanded polystyrene (EPS-PES) will be subjected to shear to simultaneously create multiple panels ICF in extremely short times (ratio 1 to 9 compared to the classic molding of panels ICF), depending on the requirement of a thickness and measure; in turn, along the processing chain, such panels ICF will be bound in a lane adjustable to size according to the measure of the panel ICF, so that the drills at very high speed adjustable. invention, as further application, able simultaneously milling the heads of the panels ICF creating the necessary design as teeth, recesses, tapping, and/or ribs negative and positive in order to stack them with a solid interlocking also through elongated elements, etc.

It should be pointed out that the steel rule cutting linear and/or pre-shaped, in hot wire panels ICF in EPS not only allows to have an exclusive breathability due to its rough surface thus obtained by the procedure, which is still a further and exclusive advantage as ideal support for be plastered with a traditional method, and have ensured adherence solidarity over time.

The method and the inventive pantograph described above therefore allow to considerably reducing the production costs of the panels ICF in EPS and not least the conventional ones. Still, these panels ICF can be printed without having to meet multiple constraints for their production, as for example, in the prior art called Insulated Concrete Forms, ICF, the fact of having to find big industries that have the specific machinery for their production.

Finally, with the inventive method, it is not difficult to find the raw material on site, with the obvious advantage of not having to transport large volumes over long distances in order to respect the environment, however, expensive, and yet, the inventive technology not only provides performance extremely unique and innovative, but also respects the environment with less pollution, making it cheaper in every kind of work in comparison with the conventional printed panels ICF.

An application of the inventive method is described below. For Example: 20 blocks/hour were used with density 15 g/It and dimensions 600×1,200×4,000 mm, whereby during molding were obtained about 1060 sheets, panels ICF thickness of 75 mm with facades representing the figures volutes, as continuous ribs horizontally (ribs modular necessary for the stacking of a plurality of panels) only to be cut in the top and bottom surfaces with the appropriate dovetail or other representations via the pantograph amended of the present invention.

The ratio of cut slabs of. panels ICF in comparison to the classic known molding was 1 to 9, and therefore are evident its unique effectiveness, as well as its industrialization cheap and easy, thanks to the lack of necessary equipment, except that implementation of machinery always existing.

As a comparative example, we used a classical and conventional aluminum mold with four figures (four panels ICF), having an average of 2.5/3.0 minutes for printed for simple sheets or panels ICF containing longitudinal slots at half height of the panel ICF even if the same are measures of maximum height of 30/40 Centimeter.

Obviously, taking into account the 2.5-3.0 minutes cited, they are printed with, such a conventional mold in aluminum 24 panels ICF: therefore, in order to achieve the same quantity obtained by the above-mentioned process of the invention, it would take at least 44 hours with such a conventional mold.

What is claimed is:

1. A pantograph machine (1) equipped with blades and hot-cutting pre-shaped punches and cutters, for machining panels, in particular ICF panels, with foamed or extruded materials in general, comprising at least one first station (1) consisting of at least one castle (1′), supported by a base (2) which houses a supporting surface (3); said castle (1′) comprising:
at least one frame (5) that carries fixed or mobile punching-cutting blades (6), to adapt to the thickness of the panel to be processed, and operatively connected to a carriage-carrying frame (9) sliding on guides, and moved through a transmission, on said carriage (9); a handling system is located which allows the frame (5) to move in the horizontal direction to escape from the castle (1′) so as to be positioned mechanically and/or manually according to an angle from 0° to 90° due to a specific hinge graduated in millimeter (13) interposed between the carriage (9) and the frame (5) to perform a cutting;
at least two slides (23) for milling, performed by a tool (24) mounted on an electro-spindle (25), placed on a carriage (14), said slides (23) being moved through a transmission and having a movement that allows the movement necessary for the machining of the grooves;
at least one frame (15) carrying fixed or mobile wires (16) to adapt to the specific cutting to be performed, operatively connected to a frame-carrier carriage (19) sliding on guides (10) and moved through a transmission, on said carriage (19) a movement is located which allows the frame (15) to move in the horizontal direction to make the cut at desired heights, said wires (16) being adapted to move in interpolation according to the vertical and horizontal directions in order to perform an inclined cut without limitation of gradation and/or according to a specific curvilinear profile;
characterized in that, above the cutting blades (6), metal devices are placed that have the same shape of the cutting blades-punches (6), that prevent the narrowing of the cut immediately after passing through the cutting blade (6) itself, so as to prevent a increased resistance and friction to cutting and any deviations of the same.

2. Pantograph machine (1) equipped with blades and hot-cutting pre-shaped punches and cutters, for machining panels, in particular ICF panels, with foamed or extruded materials in general, comprising at least one first station (1) consisting of at least a castle (11), supported by a base (2) which houses a supporting surface (3), said castle (1′) comprising:
at least one frame (5) that carries fixed or mobile punching-cutting blades (6), to adapt to the thickness of the panel to be processed, and operatively connected to a frame-carrier carriage (9) sliding on guides, and moved through a transmission, on said carriage (9) being located a handling which allows the frame (5) to move in the horizontal direction to escape from the castle (1′) so as to be positioned mechanically and/or manually according to an angle from 0° to 90° due to a specific hinge graduated in mm (13) interposed between the carriage (9) and the frame (5) to perform a cutting;
at least two slides (23) for milling, performed by a tool (24) mounted on an electro-spindle (25), placed on a carriage (14), said slides (23) being moved through a transmission and having a movement that allows the movement necessary for the machining of the grooves;
at least one frame (15) carrying fixed or mobile wires (16) to adapt to the specific cutting to be performed, operatively connected to a frame-carrier carriage (19) sliding on guides (10) and moved to means of a transmission, on. said carriage (19) a movement is located which allows the frame (15) to move in the horizontal direction to make the cut at desired heights, said wires (16) being adapted to move in interpolation according to the vertical and horizontal directions in order to perform an inclined cut without limitation of gradation and/or according to a specific curvilinear profile;
characterized in that the mechanism of translation and tilting (29) is composed of two metal arms with applied shoes and/or suction cups (32) which run in the gripping position by means of pneumatic cylinders (33), which, by exerting a pressure on the group of ICF panels to be extracted through pneumatic cylinders, perform the 90° tilting of said group and place it always with the cylinders (33) in the second station.

3. The machine (1) according to claim 1, characterized in that said castle (1′) is constituted by vertical uprights having longitudinal grooves supported by the base (2) that houses the support surface (3) equipped with electro-pneumatic cylinders.

4. The machine (1) according to claim 1, characterized in that, for the maintenance of the ICF panels cut on the sides of the castle (1′) opposite to the entry and exit of the EPS polystyrene foam block, electro-pneumatic cylinders are vertically arranged and equipped, at the end of the pointed-appendages stem (23) or suction cups (24), which intervene constraining the element actuated by the CNC system only after the passage of the frame (5) carries punches-cutting blades (6), and are deactivated returning back at the end of all the processes.

5. The machine (1) according to claim 1, characterized in that, in the upper part of the castle (1′), a suction hood (22) of the fumes generated by the cutting die and wire and a counter-hood (22 bis) are arranged for maintaining the cutting temperature.

6. The machine (1) according to claim 1, characterized in that it does not include devices to drill, but, on the same kinematic movement, it comprises a punch-carrier frame equal to the frame (5), the cutting blades (6) being optionally also a multiple punches or cutting blades (6a), to create the shape of a chessboard.

7. The machine (1) according to claim 1, characterized in that, in order to make the grooves on the panels on the 120×P and P×H sides, in order to obtain the complete realization of the block, the milling assembly (23, 24, 25) is removed from the first station and, on its same moving kinematism (26, 27, 28), translating and tilting mechanism (29) is applied, through which the group of ICF panels is brought into a second station (30) where, through the milling mechanisms (30) and (31), said panels undergo the execution of the grooves on the 120×D sides.

8. Machine (1) according to claim 1, characterized in that milling operations are obtained by kinematisms (40) consisting of electro-spindles (41) mounted on arms (42) which rotate through geared motors applied on the support (43), on the devices (40) cross-type kinematisms being mounted for handling along longitudinal and transverse directions.

9. The machine (1) according to claim 1, characterized in that it is suitable for the machining of monolithic decorative cornices from EPS (C) block and being arranged so as to obtain the movement of the cutting blades (44) and the wire (45), in order to obtain the shape of a decorative cornice in a facade and the dovetail grooves, in “T” and/or cross to the coupling of the spacer connectors on the other, the implementation of the monolithic decorative cornice over the entire length of the EPS Foam block being formed in steps, depending on the length of the cutting blades/wire and for this, in addition to the movement in X and Y, being implemented also a movement in the Z direction, the rotary table (3) allowing to orientate the EPS Foam block and all these movements being controlled by CNC systems.

10. The machine (1) according to claim 1, characterized in that it is configured for the processing of blocks or groups of ICF slabs-panels through a series of cutters (46) mounted on a support (47), all mounted on a frame (48), moved through kinematic mechanisms, on the supports (47-49-50) port electro-spindles (46), the position of said electro-spindles (46) being fixed or being varied mechanically and/or manually in distance between each other.

11. The machine (1) according to claim 1, characterized in that it is suitable for the processing of blocks or groups of ICF panels through a series of cutters (46) mounted on a support (51) moved by means of kinematic mechanisms, on the support (51) carrying electro-spindles (46), the position of said electro-spindles (46) being fixed or being varied mechanically and/or manually in distance between each other, the machine (1) mounting at least one support (51) for each side.

12. The machine (1) according to claim 1, characterized in that it is configured only with kinematic cutting dies for the realization of multiple columns and semi-columns, including the emptying configuration with inner facade to the same cited column or siphon with queues swallow and appropriate seats in “T” and/or cross to housing spacers and connectors, acts to constrain stirrups and steel bars, also elongated elements, the machine (1) having the multiple die (52) adapted to descend vertically to create and conform the columns and/or half-empty.

13. The machine (1) according to claim 1, characterized in that it is equipped with only one kinematic system for cutting multiple punches (53) for the realization of semi-columns, including their emptying, the machine (1) comprising:
a support (54) bearing spindles (55) that carry cutters (56) with manually variable distance and mechanically fastened with bolts, the spindles being put into rotation by a variable frequency motor (57) and a belt (58), all the linkage being in a fixed position and in that case the work piece by rotating by means of the rotary table (3), or also itself by turning on circular guides (59) by means of motor, rack and pinion;
a support (60) carrying many electro-spindles (61) that carry cutters (62), with variable center-distance and arrangement, all the kinematism being in a fixed position, and in that case the work piece by rotating by means of the rotary table (3), or also itself by turning on circular guides (59) by means of motor, pinion and rack.

14. The machine (1) according to claim 1, characterized in that it is suitable for the turning of the columns or half-columns, the column being mounted between a sprocket (63) in conical tips fixed to the rotary table (3), which takes advantage of the movement, and another feeder (53), mounted in the upper part of the castle (11), slide vertically by means of a pneumatic cylinder device in order to adapt to variations in height, the drag being obtained even with a hot laminated device (64) that penetrates the material moved in height.

15. The machine (1) according to claim 1, characterized in that it is adapted to be transported through a specific transport system, on the base of the machine (1) being arranged to devices cylindrical or polygonal hole for insertion of gripping means of a arm, which moves by means of hydraulic cylinders on a trailer, once inserted the gripping, by means of the hydraulic cylinder, the machine (1) undergoing a rotation of 90°, so as not to exceed the overall height maximum of 4 meters, subsequently, by means of the cylinder, the machine being translated so as to fall in the shape of the trailer.

16. The machine (1) according to claim 1, characterized in that it is equipped with a structure (A) to be inserted inside a block machine (B) for the execution of parallelepiped blocks in EPS polystyrene pre-profiled (C), the structure being constituted by an upper frame (IB) and by a lower frame (2B), which are bound and perfectly anchored to the block Molding Machine system (B) with mechanical fasteners, by two frames (4B) movable by means of hydraulic cylinders (4B), by shaped sides (6B) mechanically fastened on the bottom and on the door of the block molding machine (B) and by shaped sides (6B) mechanically fastened to the side frames (4B), on each of the frames (IB and 2B) being fixed four or more cylinders hydraulic (3B) that ensure the opening of the side frames (4B) so as to allow the extraction of the parallelepiped block in foam EPS (C) once formed, and sintered, in correspondence of the mouths of the steam outlet (11B), of introduction of the polymer (12B) and extractors (13B) of the block EPS, the surfaces of the system matrices being interrupted order not to hinder the functionality of the same block Molding Machine Manufacturers.

17. Machine (1) according to claim 1, characterized in that it is adapted to the milling machining of shaped parts from sheets and be constituted by:
at least one support surface (100) of the blank, adjustable in height with kinematic screw and motor to adapt to the size of the piece itself;
at least one centering device (200) of the work piece relative to the axis of the support surface (100), realized with bars actuated by pneumatic cylinders (not shown);
at least one counter-surface (300) actuated by a pneumatic cylinder, operating at low pressure for clamping. the work piece;
at least one anthropomorphic robot (400) bearing in the wrist at least one electro-spindle (500) carrying cutters for the machining of the work piece in any direction, even the most disparate;
at least one protective cab for operator safety.
